(19) United States
(12) Patent Application Publication
(10) Pub. No.: US 2006/0291065 A1
(43) Pub. Date: Dec. 28, 2006

(54) METHOD OF MANUFACTURING OPTICAL SHEET, OPTICAL SHEET, BACKLIGHT UNIT, DISPLAY DEVICE, AND ELECTRONIC APPARATUS

(75) Inventors: Hironori HASEI, Suwa (JP); Akira INAGAKI, Suwa (JP); Mitsuru KURIBAYASHI, Chino (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Shinjuku-ku, Tokyo (JP)

(21) Appl. No.: 11/424,050

(22) Filed: Jun. 14, 2006

(30) Foreign Application Priority Data
Jun. 28, 2005 (JP) 2005-187730

(51) Int. Cl. G02B 27/10

(52) U.S. Cl. 359/619

(57) ABSTRACT

A method of manufacturing an optical sheet provided with a plurality of microlenses on a surface of a base sheet, includes the step of applying a plurality of hemispherical liquid materials of the microlenses on the surface of the base sheet, the step of setting the base sheet in a predetermined direction in which the gravity acceleration acts on the applied hemispherical liquid materials of the microlenses to move away from the base sheet, and the step of curing the applied hemispherical liquid materials of the microlenses.

### BACKGROUND OF THE INVENTION

1. Technical Field

The present invention relates to a method of manufacturing an optical sheet equipped with microlenses, an optical sheet, a backlight unit, a display device, and an electronic apparatus.

2. Related Art

In recent years, as electronic apparatuses such as cellular phones are coming into wide use, chances are also increasing for these apparatuses to be used in lighted environments such as outdoor environment, and therefore, display devices eye-friendly even under bright outside light are desired. Further, even in an indoor environment, as TVs and monitors with large screens are also coming into wide use, bright display devices even with large screens are also desired. Among these apparatuses, liquid crystal display devices have a structure that the image on the liquid crystal panel can be recognized with light from a backlight, a floodlight device equipped on the back side thereof. Therefore, bright backlight units are desired.

In order for controlling the intensity distribution of the fluorescent light to be even, the backlight unit has a light guiding plate or a light diffusing plate provided with a pattern diffusely reflecting the light formed thereon with printing or molding. A light diffusing plate implementing a function of diffusing the light diffusely reflected by the pattern and a function of refracting the resulting light in the direction towards the liquid crystal panel with a microlens array is disclosed to the public in JP-A-2004-191611 (pages 5 through 8, FIGS. 1 and 2).

As a method of the light diffusing plate, the following method is introduced.

A method of forming the optical sheet by depositing synthetic resin on a sheet mold having a reversed shape of the surface of the microlens array, and then peeling the sheet mold.

(b) An injection molding method of injecting molten resin in a metal mold having a reversed shape of the surface of the microlens array.

(c) A method of transferring the shape of the metal mold described above by holding a reheated resin sheet between the metal mold and a metal plate to pressurize it.

(d) An extrusion sheet forming method of transferring the reversed shape of the surface of the microlens array by leading molten resin to the nip between a roll mold having the reversed shape of the surface of the microlens array on its circumferential surface and another roll.

(e) A method of coating a base layer with ultraviolet curing resin, pressing the base layer against the sheet mold, metal mold, or roll mold having the same reversed shape as described above to transfer the shape to the ultraviolet curing resin, and then irradiating ultraviolet light to cure the ultraviolet curing resin.

(f) A method of depositing uncured ultraviolet curing resin on the metal mold or the roll mold having the same reversed shape as described above, pressing it with the base layer to make it even, and then irradiating ultraviolet light to cure the ultraviolet curing resin.

(g) A method of using electron beam curing resin instead of ultraviolet curing resin.

However, since, for manufacturing the light diffusing plate, the metal mold or the roll mold is required to be manufactured in accordance with the product, the productivity in multiobjective production has been problematically low.

### SUMMARY

The invention addresses the problems described above and has an advantage of providing a method of manufacturing an optical sheet capable of forming microlenses with sort focal length without using the forming die, an optical sheet, a backlight unit, a display device, and an electronic apparatus.

An aspect of the invention is a method of manufacturing an optical sheet provided with a plurality of microlenses on a surface of a base sheet, including, as the substance, the step of applying a plurality of hemispherical liquid materials of the microlenses on the surface of the base sheet, the step of setting the base sheet in a predetermined direction in which the gravity acceleration acts on the applied hemispherical liquid materials of the microlenses to move away from the base sheet, and the step of curing the applied hemispherical liquid materials of the microlenses.

Accordingly, since a plurality of hemispherical liquid material of the microlenses is applied on the base sheet, and the microlenses are cured while the surface with the microlenses is set in the direction in which the gravity acceleration acts on the liquid material to move away from the base sheet, the material of the microlenses are cured while being pulled by gravity away from the base sheet, thus the microlenses with thick walls can be obtained. Therefore, the microlenses with a large curvature in the surface and short focal length can be formed. Since the thickness of the lens is increased utilizing gravity after applying the material of the microlenses in hemispherical shapes, there is no need for using a die for forming the lenses, the lenses can be formed with high productivity even if a wide variety of optical sheets are manufactured.

In the method of manufacturing an optical sheet according to the invention, in the setting step, the base sheet is set at a predetermined angle with the gravity acceleration direction, in the curing step, the applied hemispherical liquid materials of the microlenses can be cured with the base sheet set at the angle.

Accordingly, since the liquid material of the microlenses is cured while the base sheet is set at a predetermined angle with the gravity acceleration direction, the lens material is cured while shifted to one side. The lens having a part with more lens material becomes a multifocal lens with short focal length at the part, and a part with less lens material becomes a long focal length lens. Further, since the short focal length parts and the long focal length parts are provided to the microlenses, by using the short focal length parts of the microlenses, the microlenses can be used as short focal length microlenses with fewer amount of lens material.

Another aspect of the invention is a method of manufacturing an optical sheet provided with a plurality of microlenses on a surface of a base sheet, including, as the substance, the step of applying a plurality of hemispherical liquid materials of the microlenses on the surface of the base sheet disposed in a predetermined direction in which the gravity acceleration acts on the applied hemispherical liquid materials of the microlenses to move away from the base sheet, and the step of curing the applied hemispherical liquid materials of the microlenses.

Accordingly, since a plurality of hemispheric liquid materials are applied to the surface of the base sheet on which the gravity acceleration acts on the liquid material of the microlenses applied thereon to move away from the base sheet, the microlenses with thick walls can be formed by curing them in this condition. Therefore, if the surface of the base sheet is set towards the inverse direction of the gravity acceleration direction, and the liquid material of the microlenses is applied to the surface of the base sheet, the process of reversing the base sheet is necessary, however, in this method, the process of reversing the surface with the liquid material can be eliminated, the optical sheet can be manufactured with high productivity.

The method of manufacturing an optical sheet according to the invention can further include, between the applying step and the curing step described above, the step of setting the base sheet at a predetermined angle with the gravity acceleration direction.

Accordingly, since the liquid material is cured while the base sheet is set at an angle therewith, the lens material is cured while shifted in one side. The lens having a part with more lens material becomes a multifocal lens with short focal length at the part, and a part with less lens material becomes a long focal length lens. Since the lenses with the continuously changing focal length are formed, the optical effect of the multifocal lenses can be utilized. Further, since the short focal length parts and the long focal length parts are provided to the microlenses, by using the short focal length parts of the microlenses, the microlenses can be used as short focal length microlenses with fewer amount of lens material.

In the method of manufacturing an optical sheet according to the invention, in the applying step, the plurality of hemispherical liquid materials of the microlenses are applied in the whole area of the surface of the base sheet to which the hemispherical liquid materials of the microlenses are to be applied, in the setting step, the base sheet is set at a predetermined angle with the gravity acceleration direction, in the curing step, the hemispherical liquid materials of the microlenses in a part of the area are cured, and by repeating the step of setting and the step of curing, the liquid material of the microlenses in the entire area can be cured while setting the offset angle conditions for every parts of the area.

Accordingly, since after applying the hemispherical microlens materials on the entire surface of the base sheet, the surface with the materials is set at a predetermined angle with the gravity acceleration direction, and the materials of the microlenses are cured while setting the offset angle for every part of the area, the optical sheet with a number of multifocal lenses, whose focal length characteristics are set for every parts of the area, can be manufactured. Therefore, the optical sheet having a plurality of optical characteristics in one optical sheet can be manufactured. According to the optical sheet, for example, by disposing the microlenses so that the incident light from the light source to the optical sheet with a large incident angle passes through the short focal length portion of the microlenses, the incident light can be refracted to a desired light path, thus the optical sheet capable of transforming the intensity distribution of the light entering from the light source to the optical sheet to a desired intensity distribution of the output light can be obtained.

In the method of manufacturing an optical sheet according to the invention, in the applying step, the hemispherical liquid materials of the microlenses are applied in a part of the area of the surface of the base sheet to which the hemispherical liquid materials of the microlenses are to be applied, in the setting step, the base sheet is set at a predetermined angle with the gravity acceleration direction, in the curing step, the hemispherical liquid materials of the microlenses in the part of the area, in which the hemispherical liquid materials of the microlenses are applied, are cured, and the microlenses of the whole area can be formed by repeating the applying step, the setting step, and the curing step.

Accordingly, after applying the liquid material of the microlenses to the predetermined area of the base sheet, the liquid material is cured while the surface with the liquid material is set at a predetermined angle with the gravity acceleration direction. Since the material is applied for every area and is cured with different angles, the optical sheet having a number of multifocal lenses, whose focal length characteristics are set for every area, disposed on the base sheet can be formed. Therefore, the microlenses having a plurality of optical characteristics can be formed in one optical sheet. Further, in the curing step, when the microlenses with the same optical characteristics are formed in the plural areas, the liquid material for the microlenses can be applied to the plural areas, and then cured simultaneously, thus there is no need for selectively curing specific sections. Therefore, the curing step with high productivity can be realized.

In the manufacturing method of an optical sheet according to the invention, the microlenses can be formed as convex lenses.

Accordingly, since the lenses are made as convex lenses, the refractive effect for collecting light can be exerted.

In the method of manufacturing an optical sheet according to the invention, the step of applying the material of the microlenses can be carried out by ejecting the droplets including the material of the microlenses.

Accordingly, since the microlenses are formed by ejecting the droplet, the die for molding the lenses can be eliminated. Since the positions for forming the microlenses on the base sheet and the size of the microlenses can freely be set within a predetermined range, the productivity can be maintained in the case of multiobjective production.

The substance of the optical sheet according to another aspect of the invention is to be manufactured by the method of manufacturing an optical sheet.

Accordingly, since the optical sheet is equipped with microlenses with short focal length, the optical sheet with good light collecting efficiency can be provided. Further, since the die for molding the microlenses can be eliminated, various types of optical sheet can be manufactured with high productivity.

The substance of the optical sheet according to the invention is to include a multifocal lens formed by applying a liquid material of the microlenses on the surface of the base sheet, and curing the liquid material while setting the base sheet at a predetermined angle with the gravity acceleration direction.

Accordingly, since the optical sheet is equipped with the microlenses including a multifocal lens having a part with short focal length, when a light beam enters with a large incident angle, the light beam can be refracted to a desired direction, thus the optical sheet with good light collective property can be provided. Further, since the die for molding the microlenses can be eliminated, various types of optical sheet can be manufactured with high productivity.

An optical sheet according to another aspect of the invention is an optical sheet provided with a plurality of convex microlenses on a surface of a base sheet, wherein the plurality of microlenses includes a multifocal microlens in which a straight line passing through the center of gravity of a contact area between the multifocal microlens and the base sheet and the center of gravity of the multifocal microlens is at an angle with the normal line of the base sheet.

Accordingly, a microlens array of the optical sheet includes a multifocal microlens in which a straight line passing through the center of gravity of a contact area between the multifocal microlens and the base sheet and the center of gravity of the multifocal microlens is at an angle with the normal line of the base sheet. Therefore, the microlens includes a part with short focal length and a part with long focal length, the optical sheet having characteristics of changing the refractive effect and the exit angle in accordance with the incident angle of the incident light to the optical sheet can be provided. For example, by disposing the microlenses so that the most of the incident light to the microlenses passes through the part with short focal length, the exit angle of the output light can be controlled. As a result, the light beam can be refracted to a desired direction.

The substance of the backlight unit according to another aspect of the invention is to include the optical sheet as the light diffusing plate.

Accordingly, since the backlight unit is equipped with the optical sheet having good light collecting efficiency, the backlight unit capable of emitting high-intensity flat light can be obtained. Further, since the die for forming the microlenses can be eliminated, the backlight unit, which can be manufactured with good productivity even in multiobjective production, can be obtained.

The backlight unit according to this aspect of the invention, includes the optical sheet described above as a light diffusing plate, wherein the optical sheet includes a plurality of the microlenses, at least one of the plurality of the microlenses is a multifocal microlens, the multifocal microlens includes a part with short focal length and a part with long focal length, and can be disposed so that the part with long focal length is positioned nearer to the light source than the part with short focal length.

Accordingly, at least one of the microlenses on the backlight unit includes the part with long focal length and the part with short focal length, and the part with short focal length is positioned further from the light source. Therefore, since the light emitted from the light source passes through the part with short focal length positioned further from the light source of the microlens at high rates, the strong refractive effect of the microlenses can be obtained. As a result, the optical sheet becomes to have a microlens characteristics of good light collecting efficiency, thus the backlight unit including the optical sheet can of emit high-intensity flat light.

The substance of the display device according to another aspect of the invention is to include the backlight unit described above.

Accordingly, since the display device including the backlight unit equipped with the optical sheet having good light collecting efficiency, bright and eye-friendly display device can be obtained. Further, since the microlenses of the optical sheet dose not require a die, various types of display device can be manufactured with high productivity.

The substance of the electronic apparatus according to another aspect of the invention is to include the display device described above.

Accordingly, the electronic apparatus is equipped with a bright and eye-friendly display device. Further, since the microlenses of the optical sheet implemented therein dose not require a die, various types of electronic apparatuses can be manufactured with high productivity.

### BRIEF DESCRIPTION OF THE DRAWINGS

The invention will now be described with reference to the accompanying drawings, wherein like numbers refer to like elements.

FIG. 1 is a perspective view of a display device according to a first embodiment of the invention.

FIG. 2 is a cross-sectional view of a display device according to the first embodiment of the invention.

FIGS. 3A through 3C are each a schematic view for explaining a behavior of light in a microlens according to the first embodiment of the invention.

FIGS. 4A through 4D are each a schematic view for explaining a method of manufacturing an optical sheet according to the first embodiment of the invention.

FIG. 5 is a flowchart showing the method of manufacturing the optical sheet according to the first embodiment of the invention.

FIG. 6 is a perspective view of a display device according to a second embodiment of the invention.

FIG. 7 is a cross-sectional view of a display device according to the second embodiment of the invention.

FIG. 8 is a cross-sectional view of a display device according to a third embodiment of the invention.

FIG. 9 is a schematic view for explaining a behavior of light in a microlens according to the third embodiment of the invention.

FIGS. 10A through 10E are each a schematic view for explaining a method of manufacturing an optical sheet according to the third embodiment of the invention.

FIG. 11 is a flowchart showing the method of manufacturing the optical sheet according to the third embodiment of the invention.

FIG. 12 is a cross-sectional view of a display device according to a fourth embodiment of the invention.

FIGS. 13A through 13D are each a schematic view for explaining a method of manufacturing an optical sheet according to the fourth embodiment of the invention.

FIG. 14 is a flowchart showing the method of manufacturing the optical sheet according to the fourth embodiment of the invention.

FIG. 15 is a perspective view of an electronic apparatus.

### DESCRIPTION OF THE EMBODIMENTS

### First Embodiment

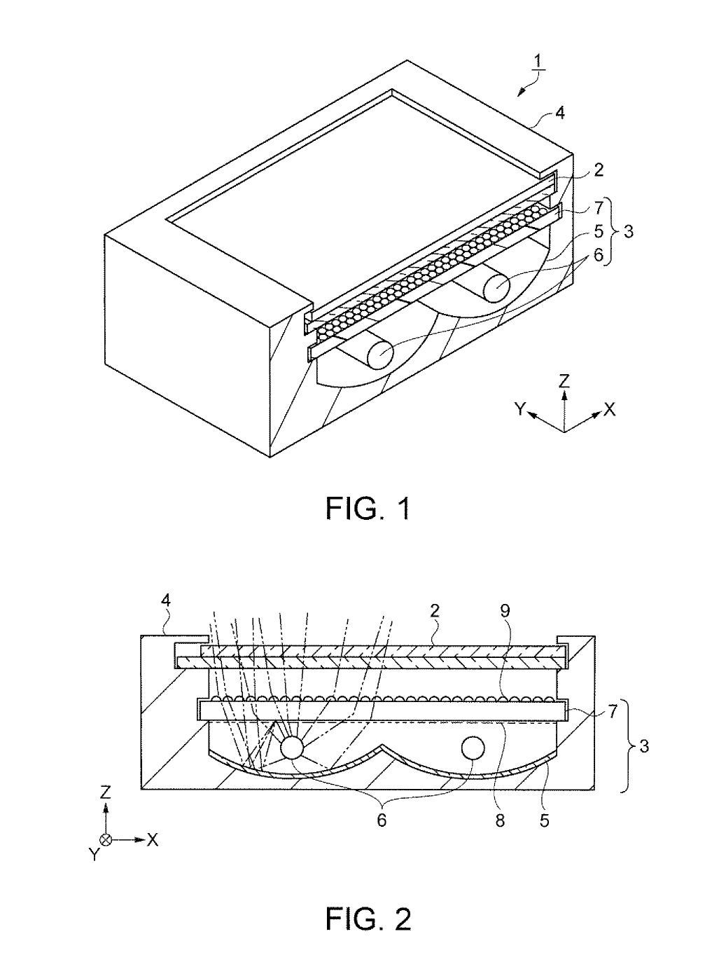

A display device as an embodiment of the invention will hereinafter be explained with reference to FIGS. 1 through 5.

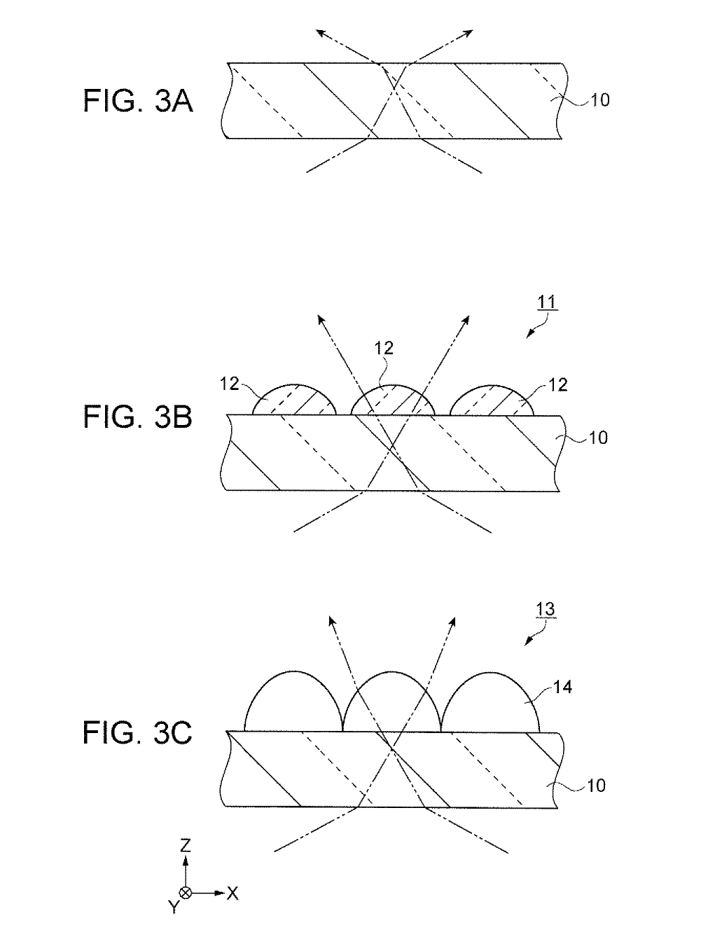

FIG. 1 is a perspective cross-sectional view of the display device according to the present invention, and FIG. 2 is a right cross-sectional view of the display device, and FIGS. 3A through 3C are schematic cross-sectional views for explaining behaviors of the light beam.

As shown in FIG. 1, the display device 1 is composed of a liquid crystal panel 2, a backlight unit 3 disposed under the liquid crystal panel 2, and a frame 4 for supporting the liquid crystal panel 2 and the backlight unit 3.

As shown in FIG. 2, the backlight unit 3 is formed inside the frame 4 shaped like a box formed from ABS resin. At the upper surface of an inner wall of the frame 4, there is disposed a reflecting sheet 5 formed of a fine foamed polycarbonate sheet having a cross-sectional shape formed of two circles linked with each other. Above the reflecting sheet 5, there are disposed two cylindrical fluorescent lamps 6 supported in the both ends by the frame 4 in parallel to each other with a predetermined distance from the reflecting sheet 5. It is arranged that the fluorescent lamps emit light with electricity supplied from a power supply section not shown in the drawings.

Above the fluorescent lamps 6, there is disposed a light diffusing plate 7 as a rectangular transparent tabular optical sheet supported by the frame 4 with a predetermined distance from the fluorescent lamps 6. The light diffusing plate 7 is provided with a dot pattern 8 printed on the surface (the side of the inverse direction of the arrow Z in the drawing) facing the fluorescent lamps 6 with a white coating material. The dot pattern 8 is arranged to have high density in an area near to the fluorescent lamps 6 and low density in an area far from the fluorescent lamps 6, thereby controlling the intensity distribution of the light transmitted through the light diffusing plate 7.

Further, on the upper surface (the side directed by the arrow Z in the drawing) of the light diffusing plate 7, is provided with fine microlenses, each having a semispherical shape elongated in the direction of protrusion and oriented so that the direction of protrusion corresponds with the upper direction (in the direction of the arrow Z) in the drawing, formed on the whole surface. Since the microlenses 9 are smaller in sizes in comparison with the dot size of the dot pattern 8, and formed in a fine pitch, it becomes difficult for the operator to recognize the shape of the dot pattern 8 from the liquid crystal panel 2 because of a blur. Further, it is arranged that the traveling directions of the light from the fluorescent lamps 6 and the light from the reflecting sheet 5 are bent towards the upper side (the side directed by the arrow Z) with the refraction effect of the microlenses 9.

In further detail, in the case in which no microlens is provided as shown in FIG. 3A, when a light beam proceeding from the lower left in the drawing (the side of the inverse direction of the arrow X, and the inverse direction of the arrow Z) to the upper right (the side of the directions of the arrow X and the arrow Z) enters the base sheet 10, which is a flat plate, the incident angle and the exit angle become equal, thus no refractive effect is exerted.

As shown in FIG. 3B, in the case in which the light diffusing plate 11 is provided with microlenses 12 with a small amount of protrusion, the light beam entering from the lower left in the drawing is bent towards the upper direction (in the direction of the arrow Z in the drawing) when being output from the light diffusing plate 11 with the refractive effect by the microlenses 12. The bending angle of the light beam is affected by the normal angle of the upper surface of the microlens 12 from which the light beam is output, and accordingly, the nearer to the horizontal direction (the direction of the arrow X in the drawing) the direction of the normal line is, the stronger the refractive effect becomes.

Therefore, as shown in FIG. 3C, in the case in which the light diffusing plate 13 is provided with the microlenses 14 each having a greater amount of protrusion and a shorter focal length, the light beam entering from the lower left in the drawing is significantly diffracted and proceeds towards the upper side (the side directed by the arrow Z) in the drawing.

Above the light diffusing plate, the liquid crystal panel 2 is disposed supported by the frame 4 in a predetermined distance therefrom. The liquid crystal panel 2 contains a liquid crystal material sealed between a pair of glass plates each provided with a pattern of transparent electrodes disposed inside thereof, and one of the pair of glass plates has a color filter formed on an inner surface thereof. An electric signal is applied to the transparent electrodes of the liquid crystal panel 2 by a drive circuit (not shown), and the light beam is partially blocked by the liquid crystal and a polarizing plate (not shown), thus an image is formed. Further, since the color filter is thus disposed, the display device 1 displays color images.

The light beam emitted from the fluorescent lamp 6 reaches the light diffusing plate 7 directly or after reflected by the reflecting sheet 5. The light diffusing plate 7 is provided with a white dot pattern formed on the lower surface thereof, and the light beam, which reaches the dot pattern 8, is reflected towards the reflecting sheet 5. On the contrary, the light beam, which enters the light diffusing plate 7, reaches the microlens 9 and is refracted upward in the drawing to illuminate the liquid crystal panel 2 from the lower side of the drawing. The operator recognizes the image displayed on the liquid crystal panel 2 by observing the light beam passing through the liquid crystal panel 2.

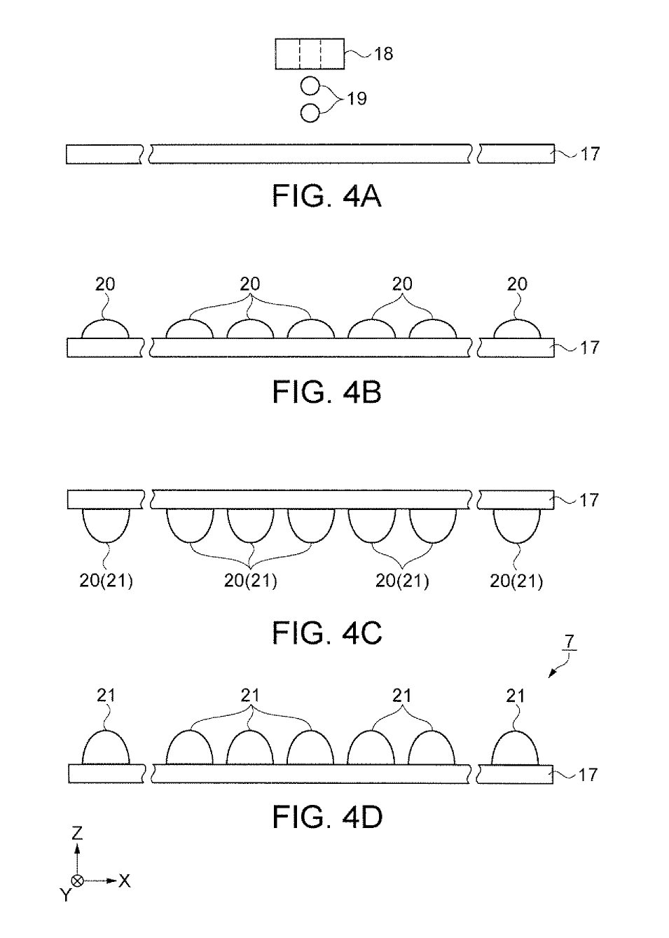

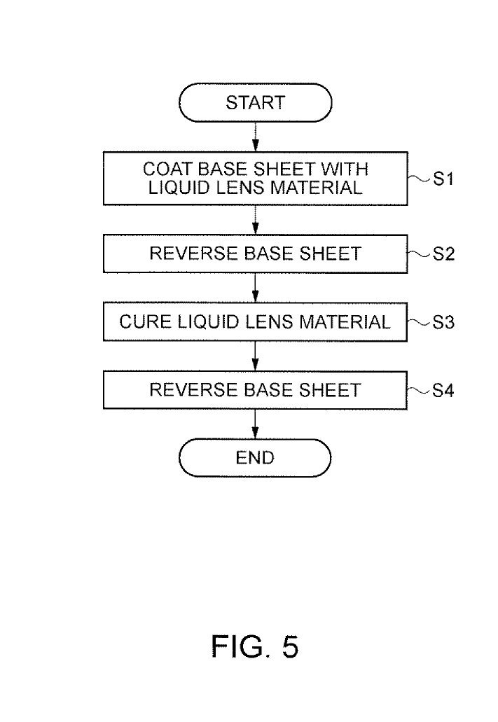

An example of a method of manufacturing the light diffusing plate 7 having the configuration described above will now be explained with reference to FIGS. 4A through 4D, and a flowchart shown in FIG. 5.

In the display device 1, other units than the light diffusing plate 7 are formed by methods known to the public. In the present embodiment, the light diffusing plate 7 is formed by a droplet ejection method (an inkjet method). Firstly, as shown in FIG. 4A, micro droplets 19 of a liquid microlens material (hereinafter referred to as a liquid lens material) are ejected from a nozzle of a head 18 of a droplet ejection device to the base sheet 17 to be applied thereto (step S1). In this case, as shown in FIG. 4B, the droplets 20 of the liquid lens material are applied as semispherical shapes in a constant interval which can prevent the droplets from overlapping with the adjacent ones. Note that, although the drawing shows only one line, the base sheet 17 extends in a plane, and therefore, the coating is performed in a plurality of lines.

Subsequently, the base sheet 17 is reversed to set the surface (coated surface) coated with the droplets 20 of the liquid lens material downward in the drawing (in the direction of the gravity acceleration) (step S2). As a result, as shown in FIG. 4C, the droplets 20 of the liquid lens material each become to have a semispherical shape elongated in the protruding section thereof in accordance with the effect of gravity.

Subsequently, the droplets 20 of the liquid lens material are cured while keeping the condition (step S3) to form the microlenses 21 on the lower surface of the base sheet 17. Then, the base sheet 17 is reversed (step S4), as shown in FIG. 4D, to complete the light diffusing plate 7.

As described above, according to the present embodiment, the following advantages are obtained.

According to the present embodiment, the microlenses 21 are formed by coating the upper surface of the base sheet 17 with the droplets 20 of the liquid lens material, then reversing the base sheet 17, and drying the droplets 20 after each of the droplets 20 of the liquid lens material forms the semispherical shape elongated in the protruding section in accordance with gravity. Therefore, thicker lenses can be formed than the lenses formed by applying them on the upper surface (the surface in the opposite direction to the direction of the gravity acceleration) and then drying them. Therefore, the microlenses 21 having short focal distances can be formed.

According to the present embodiment, they are formed by applying the droplets 20 of the liquid lens material on the base sheet 17 by ejecting them in the forms of hemispheres, and then curing them. Therefore, the microlenses 21 becomes convex lenses and are capable of refracting the light emitted from the fluorescent lamps 6 to be collected on the liquid crystal panel 2. As a result, the display device 1 can be made bright.

According to the present embodiment, since the microlenses 21 are the convex lenses with short focal distances, they can exert superior refractive effects, thus making the display device 1 further bright.

According to the present embodiment, since the light diffusing plate 7 has superior light collecting efficiency, there is no need for additionally disposing a light collecting optical sheet such as a prism sheet on the light diffusing plate 7, thus the backlight unit 3 can be made thin. Further, the productivity can be enhanced by eliminating the prism sheet for light collection.

According to the present embodiment, the microlenses 21 are formed by coating using the droplet ejection device. Therefore, the lens thickness, the lens diameter, and the distance between the lenses can be changed by changing the setting of the droplet ejection device. Therefore, there is no need for using a mold for forming the lenses, and accordingly, a wide variety of light diffusing plates can easily be manufactured with good productivity. Further, they can be manufactured with quick delivery.

According to the present embodiment, the microlenses 21 are formed by coating using the droplet ejection device. Therefore, since an area for forming the microlenses 21 can freely be set, designing with a lot of flexibility can be performed.

According to the present embodiment, since the microlenses 21 are formed by coating using the droplet ejection device, the microlenses 21 can be formed thickly with microscopic sizes. Since they are formed with a finer pattern than the printed pattern for diffusing light by the light diffusing plate 7, the printed pattern can be blurred in observing from the liquid crystal panel 2. Therefore, it is possible to make the liquid crystal panel 2 easy to be observed.

According to the present embodiment, the microlenses 21 are formed by coating using the droplet ejection device, the microlenses 21 can be formed with fewer variations in distance between the adjacent ones. Since the light diffused by the light diffusing plate 7 is provided to the liquid crystal panel 2 with fewer variations, brightness variation of a light plane forming a background can be reduced in observing from the liquid crystal panel 2. Therefore, it is possible to make the liquid crystal panel 2 easy to be observed.

### Second Embodiment

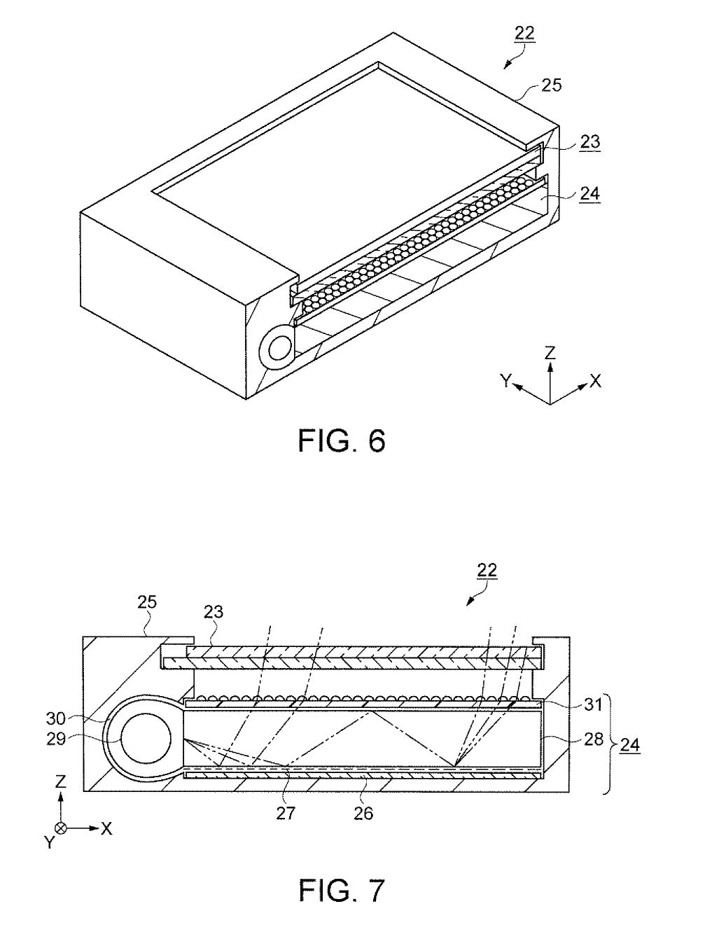

A display device as another embodiment of the invention will now be explained with reference to FIGS. 6 and 7.

FIG. 6 is a perspective cross-sectional view of a display device according to the embodiment of the invention, and FIG. 7 is a right cross-sectional view of the display device.

As shown in FIG. 6, the display device 22 is composed of a liquid crystal panel 23, a backlight unit 24 of a sidelight type disposed under the liquid crystal panel 23, and a frame 25 for supporting the liquid crystal panel 23 and the backlight unit 24.

As shown in FIG. 7, the backlight unit 24 is formed inside the frame 25 to have a box like shape with ABS resin. On the upper surface of the bottom of the frame 25, there is disposed a reflecting sheet 26 formed of a fine foamed polycarbonate. Above the reflecting sheet 26, there is disposed a light guide plate 28 formed of a transparent acrylic plate provided with a dot pattern 27 printed on the lower surface (the surface in the inverse direction of the arrow Z in the drawing) with a white coating material. In the side (in the inverse direction of the arrow X in the drawing) of the light guide plate 28, there is a cylindrical fluorescent lamp 29 as a light source with a predetermined distance from the light guide plate 28. A sheet like reflecting mirror 30 formed by evaporating aluminum on one of the surfaces is disposed so as to surround the fluorescent lamp 29 with a predetermined gap. It is arranged that the both ends of the reflecting mirror 30 are connected to the light guide plate 28, and the light beam emitted by the fluorescent lamp 29 enters the light guide plate 28 directly or after reflected by the reflecting mirror 30.

Above the light guide plate 28, there is disposed a light diffusing plate 31 provided with convex microlenses formed on a base sheet 17 made of transparent polycarbonate using the same manufacturing method as the first embodiment so that the light beam transmitted through the light guide plate 28 is refracted and proceeds upward (in the direction of the arrow Z in the drawing).

Namely, the light emitted by the fluorescent lamp 29 enters the light guide plate 28 directly or after reflected by the reflecting mirror 30, and then is reflected by the surface of the light guide plate 28 and proceeds right (in the direction of the arrow X in the drawing). The light illuminating the pattern printed on the lower surface of the light guide plate 28 is diffusely reflected, and reaches the upper surface (the surface in the direction of arrow Z in the drawing), and passes through the light guide plate 28 to reach the light diffusing plate 31 if the incident angle of the light is not greater than the critical angle. On the upper surface of the light diffusing plate 31, there are formed the convex microlenses made of transparent synthetic resin, and light beams are bent towards the upper direction (in the direction of the arrow Z in the drawing) according to the refracting operation thereof. Note that the fluorescent lamp 29, the light guide 28, and the light diffusing plate 31 each have a width in the Y direction, and accordingly, the light transmitted through the light diffusing plate 31 becomes flat light.

Above the light diffusing plate 31, there is disposed the liquid crystal panel 23. The liquid crystal panel 23 is a liquid crystal display of a matrix representation type, and the drive circuit therefor is housed in the frame 25. The drive circuit is connected to a control device (not shown) with wiring, and drives the liquid crystal display in accordance with signals from the control device. The amount of transmission of the flat light emitted by the backlight unit 24 is controlled by every pixel of the liquid crystal panel 23, and accordingly, the observer can recognize the image on the liquid crystal panel 23.

As described above, according to the second embodiment of the invention, the following advantages can be exerted in addition to the operations and the advantages of the first embodiment.

According to the second embodiment, the light diffusing plate 31, even with the backlight unit 24 of the sidelight type, makes the liquid crystal panel 23 eye-friendly by diffusing the printed dot pattern on the light guide plate 28. Further, the light diffusing plate 31 refracts the light so as to proceed towards the liquid crystal panel 23, thus the display device 22 can be made as a high-brightness device.

Since the sidelight type is adopted for disposing the fluorescent lamp 29 in the side of the light guide plate 28 and distributing the light evenly by the dot pattern 27 of the light guide plate 28, the display device 22 can be made thinner.

### Third Embodiment

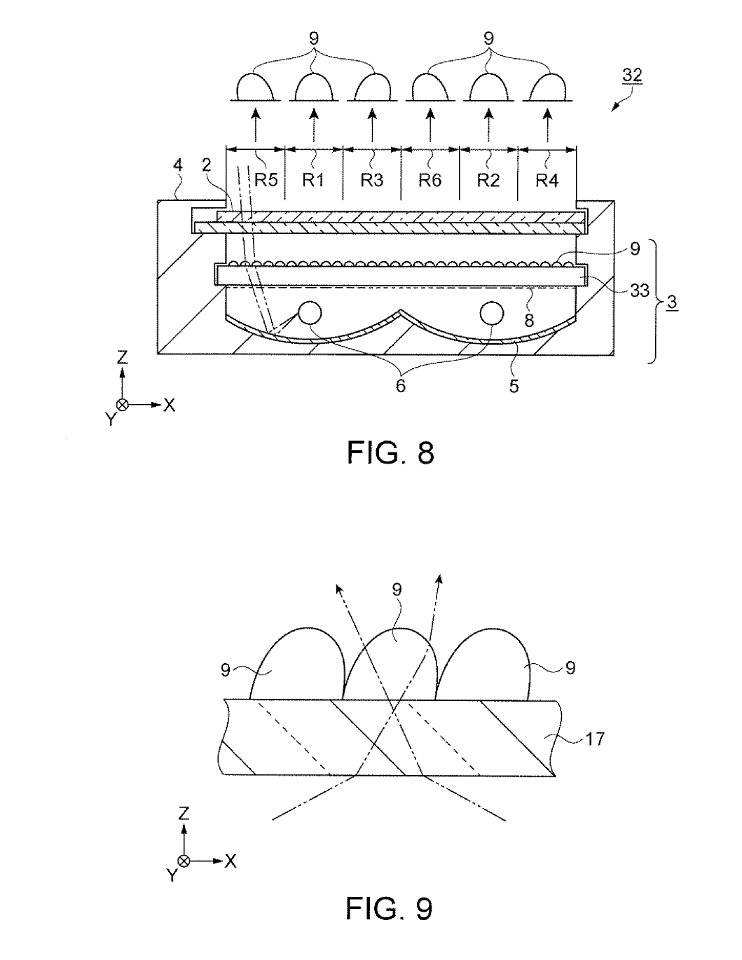

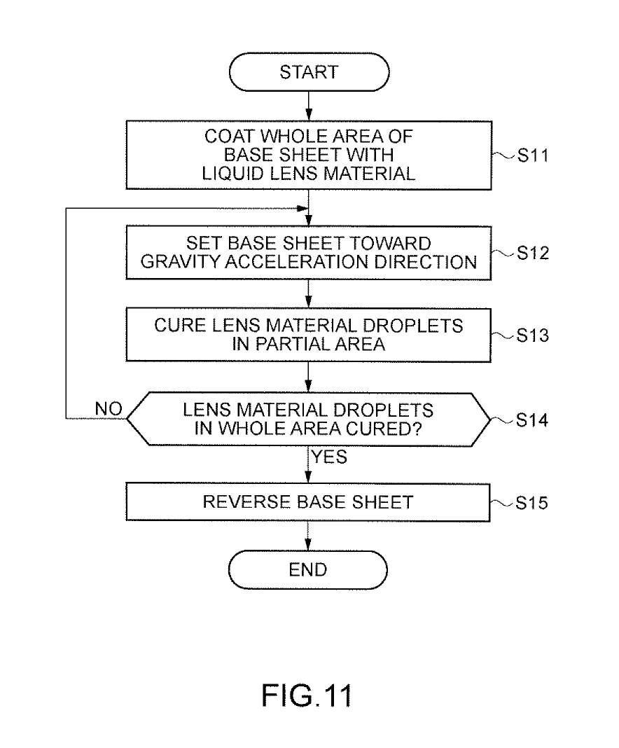

A display device as another embodiment of the invention will now be explained with reference to FIGS. 8 and 11.

FIG. 8 is a right cross-sectional view of a display device according to the present embodiment of the invention, and FIG. 9 is a schematic cross-sectional view for explaining the operation of the microlenses.

As shown in FIG. 8, the display device 32 has the same configuration as in the case with the first embodiment except a light diffusing plate 33. In the light diffusing plate 33, the surface, on which the microlenses 9 are formed, are divided into six areas, R1 through R6, each including microlenses 9 having the same shapes. The microlenses 9 in the area R1 and R2 positioned right above the fluorescent lamps 6 are each formed to have a shape of fixed focal length lens.

The right sides (in the direction of the arrow X in the drawing) of the areas R1, R2 in the drawing are partitioned as other areas of R3, R4 respectively. The microlenses 9 in the areas R3, R4 are formed asymmetrically in the arrangement direction of the fluorescent lamps 6 to be multifocal lenses each having shorter focal length in the right side (the side of the direction of the arrow X) in the drawing than the left side in the drawing.

The light beam emitted from the fluorescent lamps 6 reaches the light diffusing plate 33 directly or after reflected by the reflecting sheet 5. As shown in FIG. 9, since the light beam proceeding from the lower left to the upper right in the drawing passes through the right part of the microlens 9 in the drawing formed to have a shorter focal length, and accordingly, is subjected to the strong refraction effect. Therefore, the light beam is refracted towards the liquid crystal panel 2 (the direction of the arrow Z in the drawing), thus the display device 32 becomes a high-brightness display device. On the contrary, since the light beam proceeding from the lower right to the upper left passes through the left part of the microlens 9 in the drawing formed to have a longer focal length, and accordingly, is hardly affected by the refraction effect.

As shown in FIG. 8, since the areas R3, R4 are positioned the upper right of the nearer one of the fluorescent lamps 6, the light beams entering the light diffusing plate 33 are distributed so that most of them proceed from the lower left to the upper right in the drawing. Therefore, since the most of the light beams entering the light diffusing plate 33 pass through the part of each of the microlenses 9 having the shorter focal length, they are refracted to proceed towards the liquid crystal panel 2.

Similarly, the left sides (in the inverse direction of the arrow X in the drawing) of the areas R1, R2 in the drawing are partitioned as other areas of R5, R6 respectively. The microlenses 9 in the areas R5, R6 are formed to be multifocal lenses each having shorter focal length in the left side (the side of the inverse direction of the arrow X) in the drawing than the right side in the drawing. As shown in FIG. 8, since the areas R5, R6 are positioned the upper left of the nearer one of the fluorescent lamps 6, the light beams entering the light diffusing plate 33 are distributed so that most of them proceed from the lower right to the upper left in the drawing. Therefore, since the most of the light beams entering the light diffusing plate 33 pass through the part of each of the microlenses 9 having the shorter focal length, they are refracted to proceed towards the liquid crystal panel 2.

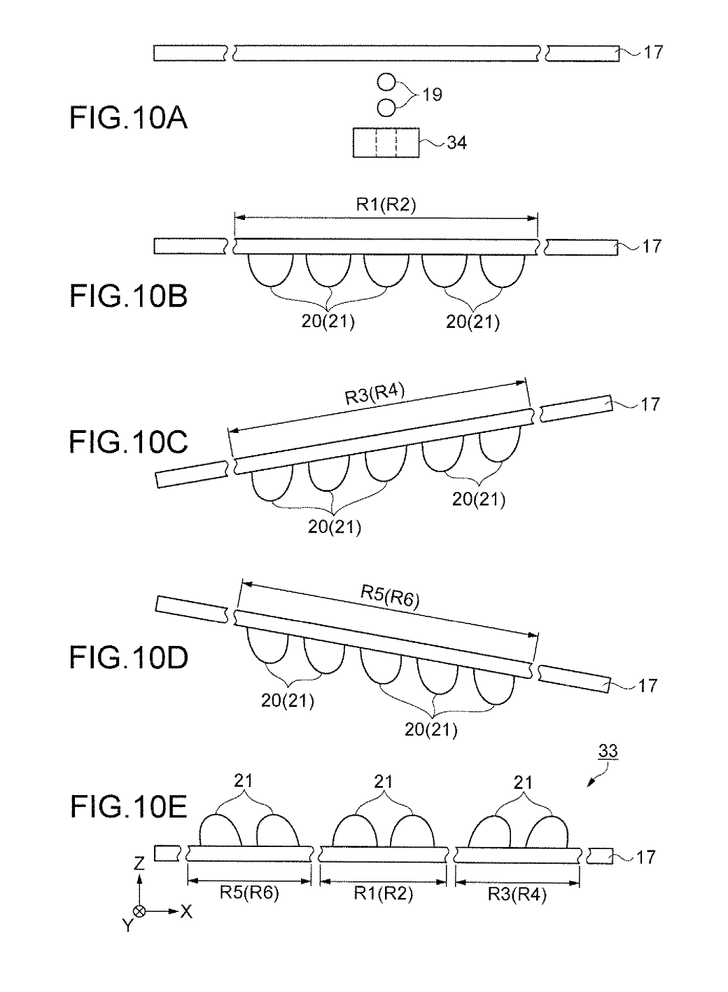

An example of a method of manufacturing the light diffusing plate 33 having the configuration described above will now be explained with reference to FIGS. 10A through 10E, and FIG. 11. FIGS. 10A through 10E are schematic views for explaining a method of forming the light diffusing plate 33, and FIG. 11 is a flow chart for showing the forming method thereof.

Firstly, the base sheet 17 provided with the dot pattern printed on the upper surface thereof and processed with a lyophobic process in the lower surface is set in the droplet ejection device, and as shown in FIG. 10A, the fine droplets 19 of the liquid lens material is applied to the whole area of the base sheet 17, where the coating is to be performed, by ejecting the droplets 19 from a nozzle of a head 34 of the droplet ejection device from the lower side of the drawing (step S11). Ultraviolet curing resin is used as the liquid lens material, and is applied to the whole area of the base sheet 17 planed to be coated.

As a result, as shown in FIG. 10B, the droplets 20 of the liquid lens material are applied with a constant distance capable of preventing the droplets 20 from overlapping. Note that, although the drawing shows only one line, the base sheet 17 extends in a plane, and therefore, the coating is performed in a plurality of lines.

Then, the base sheet 17 is set towards the gravity acceleration direction (step S12). The areas R1, R2 are irradiated with ultraviolet light in this condition to cure the droplets 20 of the liquid lens material (step S13). In detail, a mask is positioned between the ultraviolet lamp and the base sheet 17, and the ultraviolet beam emitted from the ultraviolet lamp irradiates only the specified area to cure the droplet 20 of the liquid lens material in a part of the area, thus forming the microlenses 21.

Whether or not the droplets 20 of the liquid lens material in the whole area are cured is confirmed, and if not cured (NO in step S14), then the curing process for the areas R3, R4 starts. As shown in FIG. 10C, the base sheet 17 is set at a predetermined angle with the gravity acceleration direction (step S12). The droplets 20 of the liquid lens material in the areas R3, R4 are cured in this condition to form the microlenses 21 (step S13). Whether or not the droplets 20 of the liquid lens material in the whole area are cured is confirmed, and if not cured (NO in step S14), then the curing process for the areas R5, R6 starts.

As shown in FIG. 10D, the angle setting (step S12) and the curing (step S13) are similarly performed for the areas R5, R6 to form the microlenses 21 on the lower surface of the base sheet 17. Whether or not the droplets 20 of the liquid lens material in the whole area are cured is confirmed, and since there is no more droplet to be cured (YES in step S14), the base sheet 17 is reversed (step S15) to complete the light diffusing plate 33 shown in FIG. 10E.

In the areas R1, R2, since the droplets 20 of the liquid lens material are cured while setting the base sheet 17 towards the gravity acceleration direction, the fixed focal length lenses are obtained. In the areas R3, R4, R5, and R6, since the droplets 20 of the liquid lens material are cured in the condition in which the base sheet 17 is set at an angle, the shapes formed by shifting the droplets 20 of the liquid lens material to one side of the microlenses 21 are formed, which function as multifocal lenses.

As described above, according to the third embodiment of the invention, the following advantages can be exerted in addition to the operations and the advantages of the first and the second embodiments.

The surface of the light diffusing plate 33 is divided into a plurality of areas in accordance with the distribution of the orientations of the incident light beams to the light diffusing plate 33, and the fixed focal length microlenses 9 and the multifocal microlenses 9 are respectively disposed. By disposing the multifocal microlenses 9 in the area R3, R4, R5, and R6 with high distribution density of incident light beams to the light diffusing plate 33 with large incident angles so that the incident light beams pass through the side of the multifocal microlenses 9 having shorter focal lengths, the light beams can be refracted with larger angles. Therefore, the light beams can be collected to the direction of the liquid crystal panel 2, thus the display device 32 can be made as a high-brightness display device.

Since in the manufacturing method of the light diffusing plate in the areas R3, R4, R5, and R6, after applying the droplets 20 of the liquid lens material using the droplet ejection device, the droplets 20 of the liquid lens material are cured while the base sheet 17 is set at an angle, the shapes formed by shifting the liquid lens material to one side of the microlenses 21 are obtained. Therefore, the lenses each including a part with a shorter focal length and a part with a longer focal length can be obtained.

### Fourth Embodiment

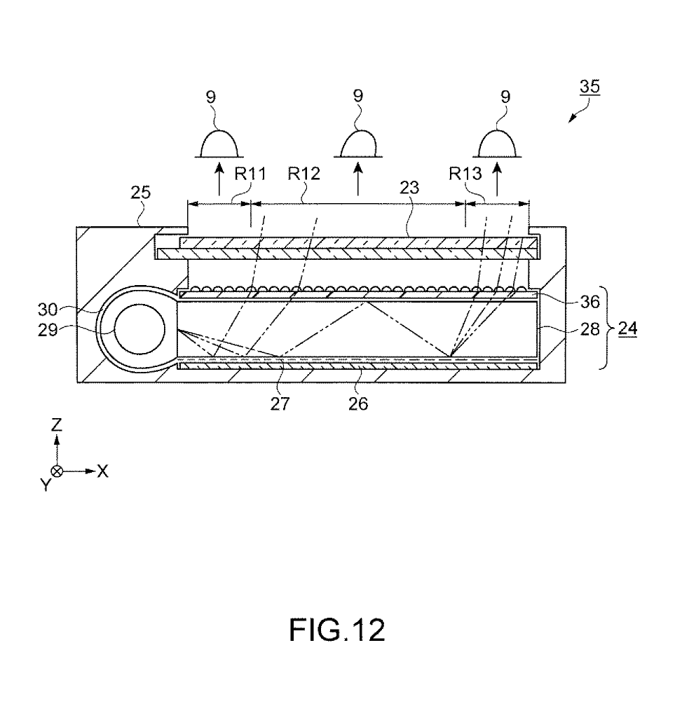

A display device as another embodiment of the invention will now be explained with reference to FIG. 12. FIG. 12 is a right cross-sectional view of an embodiment ob the invention.

As shown in FIG. 12, the display device 35 is equipped with the sidelight type of backlight unit 24, and has the same configuration as in the case of the second embodiment except the light diffusing plate 36. The surface of the light diffusing plate 36 provided with the microlenses 9 formed thereon is divided into three areas R11 through R13, each including the microlenses 9 having the same shapes.

The microlenses 9 in the area R11 positioned adjacent to the fluorescent lamps 29 are each formed to have a shape of fixed focal length lens. The light beam emitted from the fluorescent lamp 29 enters the light guide plate 28, and is diffusedly reflected by the dot pattern printed on the light guide plate 28, and then reaches the microlenses 9 of the light diffusing plate 36. Since the area R11 is near to the fluorescent lamp 29, the light beams reaching the area R11 include the light beams diffusedly reflected by an adjacent part of the dot pattern 27 of the light guide plate 28 to the fluorescent lamp 29 at high rates. The incident angle of the light beam entering from the adjacent part of the dot pattern 27 of the light guide plate 28 to the fluorescent lamp 29 to the area R11 of the light diffusing plate 36 is an acute angle, and the diffused light at that point has the distribution towards the upper direction (in the direction of the arrow Z) in the drawing. Since the fixed focal length microlenses 9 are disposed in the area R11, the light beams proceeding at slight angles with the upper direction in the drawing towards the horizontal direction (the light transmission direction in the light guide plate 28, namely in the direction of the arrow X or the inverse direction of the arrow X in the drawing) are refracted to proceed more nearly to the upper direction in the drawing.

The microlenses 9 in the area R12 positioned at the center of the light diffusing plate 36 are each formed as a multifocal lens having a part with shorter focal length in the right. The light beams reaching the area R12 are the light beams diffusedly reflected by a distant part of the dot pattern 27 from the fluorescent lamp 29. Since the incident angles of the light beams directly reaching the dot pattern 27 from the fluorescent lamp 29 and the light beams reaching the dot pattern 27 after reflected inside the light guide 28 are obtuse angles, the distribution of the light beams diffusedly reflected by the dot pattern 27 includes the light beams, which proceed from the lower left to the upper right in the drawing and have obtuse reflection angles, at high rates. The light beams entering the light diffusing plate 36 become to have a distribution including the light beams with obtuse incident angles at high rates, and such light beams each pass through the right part of the microlens 9.

In the area R12, since the microlenses 9 are formed as the multifocal lenses each having short focal length part in the right in the drawing, the light beam passing thorough the right part of the microlens 9 is subjected to the strong refraction effect to proceed towards the upper direction in the drawing.

The microlenses 9 in the area R13 positioned in the right end of the light diffusing plate 36 are each formed to have a shape of fixed focal length lens. The light beams reaching the area R13 include the light beams, which enters from the left in the drawing to the light guide 28, and are repeatedly reflected inside the light guide plate 28, and are diffusedly reflected by the dot pattern 27, and then reach the area R13, and the light beams, which are reflected by the right end surface of the light guide plate 28 or by the frame 25 adjacent to the right end surface to reach the dot pattern 27, and are diffusedly reflected at that point, and then reaches the area R13. Therefore, the microlenses 9 in the area R13 have the incident light from the lower left in the drawing and the incident light from the lower right in the drawing. In the area R13, since the microlenses 9 of fixed focal length are disposed, both the light beams from the lower left and from the lower right become to proceed towards the upper direction in the drawing owing to the refractive effect.

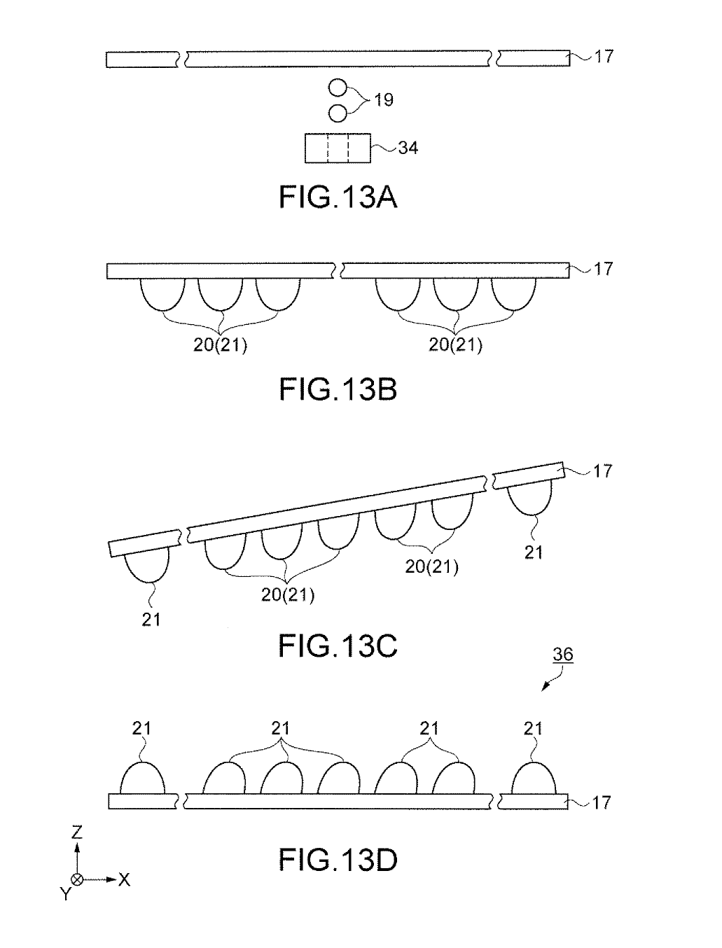

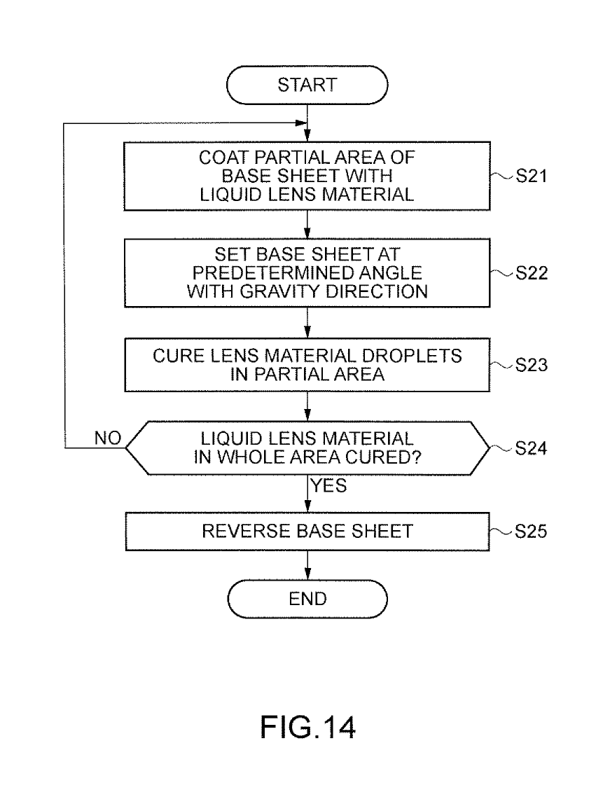

An example of a method of manufacturing the light diffusing plate 36 having the configuration described above will now be explained with reference to FIGS. 13A through 13D, and FIG. 14. FIGS. 13A through 13D are schematic views for explaining the method of manufacturing the light diffusing plate 36, and FIG. 14 is a flow chart for showing the forming method thereof. Firstly, the base sheet 17 provided with a dot pattern printed on the upper surface thereof, and processed with the lyophobic process on the lower surface thereof is set in the droplet ejection device. As shown in FIG. 13A, the fine droplets 19 of the liquid lens material is applied to the areas R11, R13 of the base sheet 17 by ejecting the droplets 19 from the head 34 of the droplet ejection device from the lower side of the drawing (step S21). Ultraviolet curing resin is used as the liquid lens material.

As a result, as shown in FIG. 13B, the droplets 20 of the liquid lens material are applied with a constant distance capable of preventing the droplets 20 from overlapping. Then, the base sheet 17 is set towards the gravity acceleration direction (step S22). The areas R11, R13 are irradiated with ultraviolet light in this condition to cure the droplets 20 of the liquid lens material (step S23).

Whether or not the droplets 20 of the liquid lens material in the whole area are cured is confirmed, and since there is the droplet to be cured (NO in step S24), the coating process for the area R12 is started. As shown in FIG. 13A, the fine droplets 19 of the liquid lens material is applied to the area R12 of the base sheet 17 by ejecting the droplets 19 from the head 34 of the droplet ejection device from the lower side of the drawing (step S21). As shown in FIG. 13C, the base sheet 17 is set at a predetermined angle with the gravity direction (step S22). The area R12 are irradiated with ultraviolet light in this condition to cure the droplets 20 of the liquid lens material (step S23).

Whether or not the droplets 20 of the liquid lens material in the whole area are cured is confirmed, and since there is no more droplet to be cured (YES in step S24), the base sheet 17 is reversed (step S25) to complete the light diffusing plate 36 shown in FIG. 13D.

As described above, according to the second embodiment of the invention, the following advantages can be exerted in addition to the operations and the advantages of the embodiment described above.

In the display device 35 equipped with the sidelight type of backlight unit 24, the surface of the light diffusing plate 36 is divided into three areas in accordance with the distribution of the orientations of the incident light to the light diffusing plate 36, and the fixed focal length microlenses 9 and the multifocal microlenses 9 are respectively disposed. By disposing the multifocal microlenses 9 in the area R12 with high distribution density of incident light beams to the light diffusing plate 36 with large incident angles so that the incident light beams pass through the part of the multifocal microlenses 9 having shorter focal lengths, the light beams can be refracted with larger angles. As a result, the light beams can be collected to the direction of the liquid crystal panel 2, thus the display device 35 can be made as a high-brightness display device.

In the display device 35 equipped with the sidelight type of backlight unit 24, the microlenses 9 in the area R11 adjacent to the fluorescent lamp 29 and the microlenses 9 in the area R13 adjacent to a distant one of the end surfaces of the light diffusing plate 36 from the fluorescent lamp 29 are formed as the fixed focal length lenses. Therefore, both of the incident light from the left in the drawing and the incident light from the right in the drawing can be refracted to proceed upwards in the drawing, thus the display device 35, which is bright in the end portions of the liquid crystal panel 23, can be provided.

An electronic apparatus equipped with either one of the display devices manufactured according to the embodiments described above will now be explained.

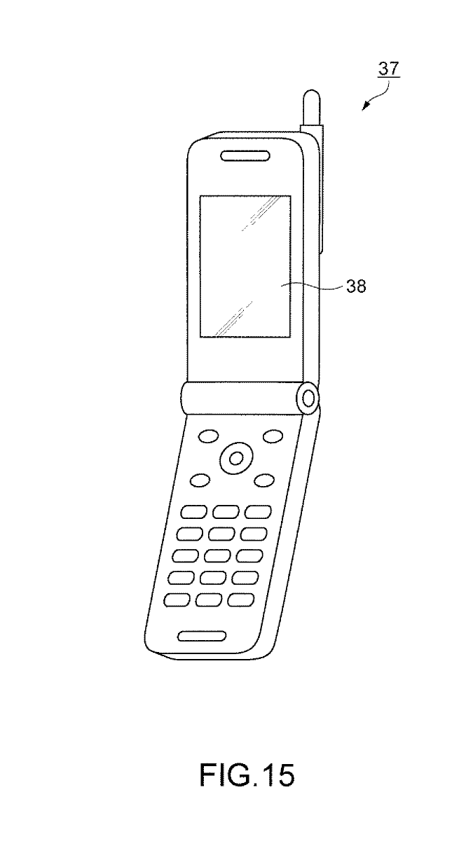

FIG. 15 is a perspective view showing an example of an electronic apparatus 37 such as a mobile phone. A main body of the electronic apparatus 37 is equipped with a display device 38 for displaying information, and either one of the display devices manufactured in accordance with first through fourth embodiments is disposed as the display device 38. The display device 38 disposed in the electronic apparatus 37 is manufactured according to the first through the fourth embodiments. Namely, the electronic apparatus has a bright display section, and offers high productivity.

Note that embodiments of the invention is not limited to the embodiments described above, but can be put into practice as described below.

Although in the second and fourth embodiments, the lower surface (the opposite surface to the surface on which the microlenses are formed) (the surface in the inverse direction of the arrow Z in FIG. 2) of the light diffusing plate 31, 36 remains flat, it can be provided with unevenness. Sticking with the light guide plate 28 can be prevented.

Although in the embodiments described above, polycarbonate is used as the base sheet 17 for the light diffusing plate 7, 31, 33, 36, it is not particularly limited thereto, but synthetic resin such as polyethylene terephthalate, polyethylene naphthalate, acrylic resin, polystyrene, polyolefin, cellulose acetate, or weatherproof polyvinyl chloride can also be used as the base sheet 17. A transparent sheet with high light transmission is preferable.

Although in the embodiments described above, the microlenses are made of synthetic resin, fillers, plasticizers, stabilizers, deterioration inhibitors, dispersants can be combined therewith. The stabilized ejection can be performed. Further, the quality deterioration can also be prevented.

Although in the embodiments described above, the microlenses are made of synthetic resin, fine particles of a silica group material as a light diffusing agent can be combined therewith. The light diffusing effect can be enhanced.

Although in the embodiments described above, the plastic sheet formed from the fine foamed polycarbonate is used as the reflecting sheet 5, 26, it is not particularly limited. A plastic sheet with the addition of white dye or pigment can also be used. For example, titanium oxide, barium sulfate, calcium carbonate, aluminum hydroxide, magnesium carbonate, or aluminum oxide can be used as a white coating material. Further, polyester resin or polyolefin resin can be used as a resin material. Further, materials with high reflectance such as a silver foil or an aluminum foil can also be used.

Although in the embodiments described above, the fluorescent lamps 6, 29 are used as the light source, a white light, an LED, or a cold cathode tube can also be used.

Although in the first and the third embodiments described above, two fluorescent lamps 6 are used, the number of fluorescent lamps can appropriately be determined in accordance with the size of the display device 1, 3 or the necessary brightness. Although in the second and fourth embodiments, the fluorescent lamp 29 is disposed on one side surface of the light guide plate 28, the fluorescent lamps 29 can be disposed on a plurality of side surfaces out of four side surfaces of the light guide plate 28 in accordance with the required brightness. Although in the second and fourth embodiments described above, one fluorescent lamp 29 is disposed on one side surface of the light guide plate 28, a plurality of fluorescent lamps 29 can be disposed per one side surface of the light guide plate 28 in accordance with the size of the light guide plate 28, the length of the fluorescent lamp, and the required brightness.

Although in the second and fourth embodiments described above, the pattern is formed on the lower surface of the light guide plate 28 with the white coating material, unevenness can be provided to perform diffused reflection.

Although in the second and fourth embodiments, the acrylic resin is used as the material of the light guide plate 28, it is not particularly limited, but any transparent materials can be used. For example, polycarbonate, methacrylate resin, polystyrene, styrene acrylonitrile resin, methyl methacrylate, styrene methyl methacrylate resin, polyethersulfone, and so on can be used.

Although in the embodiments described above, the inkjet method is used for applying the material of the microlenses, the method is not limited thereto. A screen printing method, a offset printing method, application with a dispenser, a spray coating with masking can also be used.

Although in the embodiments described above, the drying process and ultraviolet irradiation are used for curing the material of the microlenses, the curing process is not limited thereto. It is possible that radiation curing resin other than the ultraviolet curing resin is used as the material of the microlenses, and cured by irradiation with the radiation other than the ultraviolet light. Note here that radiation is used as a collective term of visible light, far-ultraviolet radiation, X-ray, and electron beam.

Although in the embodiments described above, the microlenses are formed so as not to overlap each other, this is not a limitation. The adjacent microlenses can be merged as long as the light diffusing function and the light collecting function can be obtained.

The optical sheet according to the embodiments of the invention can be applied to various optical devices besides the usages described above, for example, it can be used as an optical component provided to a light acceptance surface of a solid-state image sensing device, a screen for a projector, an optical head for a laser printer.

The light diffusing plate 33 of the backlight unit 3 according to the third embodiment described above is configured by disposing the three types of microlenses composed of the fixed focal length microlenses and two types of multifocal microlenses with different offset angles on the three types of areas. The configuration is not limited thereto. The microlenses 9 can be formed so that the offset angles of the lenses are continuously changing in the direction in which the fluorescent lamps 6 are arranged. As an example of the method of forming such microlenses, firstly, the droplets 20 of the lens material composed of the ultraviolet curing resin or the like are applied to the whole area of the base sheet 17 to which the lens material is to be applied, and then the surface coated with the droplets 20 is set towards the gravity acceleration direction. Then, while changing the angle of inclination of the base sheet 17, the droplets 20 of the lens material are gradually scanned with the ultraviolet beam having a linear shape for curing the droplets 20, thereby forming the microlenses 9 having continuously changing offset angles. Further, in the backlight unit 24 of the sidelight type according to the fourth embodiment described above, the microlenses 9 can similarly be formed to have the offset angles continuously changing in the direction in which the light transmitted in the light guide plate 28.

Accordingly, since the offset angle of each of the microlenses 9 is set according to the distribution of the incident angle and intensity of the incident light to the light diffusing plate 33, 36 in each point of the light diffusing plate 33, 36, the light diffusion plate 33, 36 exerting further preferable refractive effect can be provided.

In the light diffusing plate 33 of the backlight unit 3 according to the third embodiment described above, the surface of the base sheet 17 to which the microlenses 9 are to be formed is set towards the gravity acceleration direction, and then the droplets 20 of the lens material composed of the ultraviolet curing resin or the like are applied to the whole area in which the microlenses 9 are to be formed. This is not a limitation, and the surface of the base sheet 17 on which the microlenses 9 are formed can be set towards the inverse direction of the gravity acceleration direction, and then the droplets 20 of the lens material of the ultraviolet curing resin can be applied to the whole area to which the microlenses 9 are planned to be formed. And then, the base sheet 17 is reversed to sequentially set the surface provided with the droplets at predetermined angles with the gravity acceleration direction, and a part of the area can sequentially be irradiated with the ultraviolet light to cure the respective droplets.

Accordingly, since a typical droplet ejection device for ejecting droplets in the gravity acceleration direction can be used, the productive equipment can easily be prepared.

In the light diffusing plate 36 of the backlight unit 24 according to the fourth embodiment, the surface on which the microlenses 9 are formed is set in the gravity acceleration direction, and the droplets 20 are applied to a part of the area, and then the droplets are cured. This is not a limitation, and the surface of the base sheet 17 on which the microlenses 9 are formed can be set towards the inverse direction of the gravity acceleration direction, and then the droplets 20 of the lens material can be applied to a part of the area to which the microlenses 9 are planned to be formed, and then the droplets can be cured after reversing the surface with the droplets.

As an example of the manufacturing method, the base sheet 17 is set towards the inverse direction of the gravity acceleration direction, and the droplets 20 of the lens material composed of the ultraviolet curing resin or the like are applied to a part of the area. The base sheet 17 is then reversed, and the droplets are cured by the irradiation of the ultraviolet light in the condition of setting the surface with the droplets towards the gravity acceleration direction, an then the base sheet is reversed. Subsequently, the droplets 20 of the lens material are similarly applied to another part of the area, and the base sheet is reversed to set the surface with the droplets in the gravity acceleration direction, and the droplets can be cured by the ultraviolet irradiation.

Accordingly, since a typical droplet ejection device for ejecting droplets in the gravity acceleration direction can be used, the productive equipment can easily be prepared.

What is claimed is:

1. A method of manufacturing an optical sheet provided with a plurality of microlenses on a surface of a base sheet, comprising:
applying a plurality of hemispherical liquid materials of the microlenses on the surface of the base sheet;
setting the base sheet in a predetermined direction in which the gravity acceleration acts on the applied hemispherical liquid materials of the microlenses to move away from the base sheet; and
curing the applied hemispherical liquid materials of the microlenses.

2. The method of manufacturing an optical sheet according to claim 1, wherein
in the setting step, the base sheet is set at a predetermined angle with the gravity acceleration direction,
in the curing step, the applied hemispherical liquid materials of the microlenses are cured with the base sheet set at the angle.

3. A method of manufacturing an optical sheet provided with a plurality of microlenses on a surface of a base sheet, comprising:
applying a plurality of hemispherical liquid materials of the microlenses on the surface of the base sheet disposed in a predetermined direction in which the gravity acceleration acts on the applied hemispherical liquid materials of the microlenses to move away from the base sheet; and
curing the applied hemispherical liquid materials of the microlenses.

4. The method of manufacturing an optical sheet according to claim 3, further comprising between the applying step and the curing step:
setting the base sheet at a predetermined angle with the gravity acceleration direction.

5. The method of manufacturing an optical sheet according to claim 2, wherein
in the applying step, the plurality of hemispherical liquid materials of the microlenses are applied in the whole area of the surface of the base sheet to which the hemispherical liquid materials of the microlenses are to be applied,
in the setting step, the base sheet is set at a predetermined angle with the gravity acceleration direction,
in the curing step, the hemispherical liquid materials of the microlenses in a part of the area are cured,
and the setting step and the curing step are repeated to cure the hemispherical liquid materials of the microlenses in the whole area by setting the sheet setting conditions for every part of the area.

6. The method of manufacturing an optical sheet according to claim 2, wherein
in the applying step, the hemispherical liquid materials of the microlenses are applied in a part of the area of the surface of the base sheet to which the hemispherical liquid materials of the microlenses are to be applied,
in the setting step, the base sheet is set at a predetermined angle with the gravity acceleration direction,
in the curing step, the hemispherical liquid materials of the microlenses in the part of the area, in which the hemispherical liquid materials of the microlenses are applied, are cured,
and the applying step, the setting step, and the curing step are repeated to form the microlenses in the whole area.

7. The method of manufacturing an optical sheet according to claim 1, wherein
the microlenses are each formed as a convex lens.

8. The method of manufacturing an optical sheet according to claim 1, wherein
in the applying step, the plurality of hemispherical liquid materials of the microlenses are applied on the surface of the base sheet by ejecting droplets including the liquid material of the microlenses.

9. An optical sheet manufactured by the method according to claim 1.

10. An optical sheet manufactured by the method according to claim 2, comprising:
a multifocal lens formed by applying the liquid material of the microlenses on the surface of the base sheet, and curing the applied liquid material of the microlenses with the base sheet set at a predetermined angle with the gravity acceleration direction.

11. An optical sheet provided with a plurality of convex microlenses on a surface of a base sheet, wherein
the plurality of microlenses includes a multifocal microlens in which a straight line passing through the center of gravity of a contact area between the multifocal microlens and the base sheet and the center of gravity of the multifocal microlens is at an angle with the normal line of the base sheet.

12. A backlight unit comprising the optical sheet according to claim 9 as a light diffusing plate.

13. A backlight unit comprising the optical sheet according to claim 10 as a light diffusing plate, wherein
the optical sheet includes a plurality of the microlenses, at least one of the plurality of the microlenses is a multifocal microlens, the multifocal microlens includes a part with short focal length and a part with long focal length, and is disposed so that the part with long focal length is positioned nearer to the light source than the part with short focal length.

14. A display device comprising the backlight unit according to claim 12.

15. An electronic apparatus comprising the display device according to claim 14.
